(19) United States
(12) Patent Application Publication
(10) Pub. No.: US 2009/0303535 A1
(43) Pub. Date: Dec. 10, 2009

(54) DOCUMENT MANAGEMENT SYSTEM AND DOCUMENT MANAGEMENT METHOD

(75) Inventors: Kazuhiro Ogura, Hiratsuka-shi (JP); Shinji Makishima, Sumida-ku (JP); Akihiro Mizutani, Kawasaki-shi (JP); Toshihiro Ida, Ota-ku (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/476,667

(22) Filed: Jun. 2, 2009

Related U.S. Application Data
(60) Provisional application No. 61/059,097, filed on Jun. 5, 2008.

(51) Int. Cl. G06F 15/00; G06K 9/46

(52) U.S. Cl. 358/1.15; 382/190

(57) ABSTRACT

There is provided a technology of realizing adequate management of a version number suitable for the actual contents of each of the documents without imparting respective IDs to a plurality of documents which are management objects.

The document management system includes an image acquisition unit acquiring a document image, a similarity judgment unit judging similarity between contents of a first document image and contents of a second document image acquired by the image acquisition unit, a relevance judgment unit judging that a document corresponding to the first document image and a document corresponding to the second document image represent the same object item if the judged similarity between the first document image and the second document image exceeds a predetermined threshold value, and a version number judgment unit judging whether the version number of each document is equal to or different from those of other documents in a plurality of documents judged to represent the same object item by the relevance judgment unit, based on the judged result of the similarity judgment unit.

### CROSS-REFERENCE TO RELATED APPLICATION

This application is based upon and claims the benefit of priority from: U.S. provisional application 61/059097, filed on Jun. 5, 2008, the entire contents of each of which is incorporated herein by reference.

### TECHNICAL FIELD

The present invention relates to a technology of managing a version number of a document managed by a document management system.

### BACKGROUND

Conventionally, when any document is created, a final version may be obtained by revising the contents thereof.

In addition, in a document which is created by a plurality of users, each of the users holds the copy of the document having the same contents. In this case, if each of the users performs an operation regardless of the contents of the operations of the other users, each of the users may not know the existence of a newest version of the document created by another user and may revise an old version of the document.

Such an operation for revising the old version of the document may cause generation of re-processing of the operation or delay of decision of an open version.

Accordingly, a technology of managing the version number of a document which is a management object is disclosed (for example, see JP-A-2000-261584 or JP-A-2002-197101). However, in the conventional technologies, an ID is intentionally imparted to the document which is the management object and these technologies cannot be applied to a document to which an ID is not imparted. In addition, the impartment of the ID may not be preferable in view of appearance, according to the contents of the document.

A technology of embedding an RFID in paper on which a document is printed and managing the version number of a document based on information stored in the RFID is known (for example, see JP-A-2006-197324). In the conventional technology, an appearance problem of printing the ID on the document is solved. However, since the paper in which the RFID is embedded is necessary, the necessity for imparting the ID to the document is not changed and a management burden problem occurs.

In addition, a method of estimating a similarity between document images is suggested (for example, see JP-A-2007-48057).

### SUMMARY

An object of the present invention is to provide a technology of realizing adequate management of a version number suitable for the actual contents of each of documents, without imparting respective IDs to a plurality of documents which are management objects.

In order to solve the above-described problems, according to an aspect of the present invention, there is provided a document management system including: an image acquisition unit acquiring a document image representing contents of a document as a management object; a similarity judgment unit judging similarity between contents of a first document image acquired by the image acquisition unit and contents of a second document image acquired by the image acquisition unit; a relevance judgment unit judging that a document corresponding to the first document image and a document corresponding to the second document image represent the same object item if the similarity between the first document image and the second document image judged by the similarity judgment unit exceeds a predetermined threshold value; and a version number judgment unit judging whether the version number of each document is equal to or different from those of other documents in a plurality of documents judged to represent the same object item by the relevance judgment unit, based on the judged result of the similarity judgment unit.

According to another aspect of the present invention, there is provided a document management method including: acquiring a document image representing contents of a document as a management object; judging similarity between contents of an acquired first document image and contents of an acquired second document image; judging that a document corresponding to the first document image and a document corresponding to the second document image represent the same object item if the judged similarity between the first document image and the second document image exceeds a predetermined threshold value; and judging whether the version number of each document is equal to or different from those of other documents in a plurality of documents judged to represent the same object item, based on the judged result.

According to another aspect of the present invention, there is provided a document management program for executing, on a computer, a process of acquiring a document image representing contents of a document as a management object; judging similarity between contents of an acquired first document image and contents of an acquired second document image; judging that a document corresponding to the first document image and a document corresponding to the second document image represent the same object item if the judged similarity between the first document image and the second document image exceeds a predetermined threshold value; and judging whether the version number of each document is equal to or different from those of other documents in a plurality of documents judged to represent the same object item, based on the judged result.

### DESCRIPTION OF THE DRAWINGS

FIG. 1 is a system configuration diagram explaining the schematic configuration of a document management system according to an embodiment of the present invention.

FIG. 2 is a functional block diagram explaining the document management system according to the embodiment of the present invention.

FIG. 3 is a view showing an example of information such as a document accumulated in a history server, metadata about the document and the like.

FIG. 4 is a flowchart explaining a process of the document management system according to the present embodiment.

FIG. 5 is a flowchart showing a process when a document is copied by a multi function peripheral.

FIG. 6 is a view explaining the outline of a document which is a copy object.

FIG. 7 is a view showing an example of a warning message which is displayed on a screen of a display unit 804 by a report unit 108.

FIG. 8 is a flowchart showing a process of selecting an open version.

FIG. 9 is a view showing the outline of a document which will be copied by a user.

FIG. 10 is a view showing another example of a warning message which is displayed on the screen of the display unit 804 by the report unit 108.

### DETAILED DESCRIPTION

Hereinafter, the embodiment of the present invention will be described with reference to the accompanying drawings.

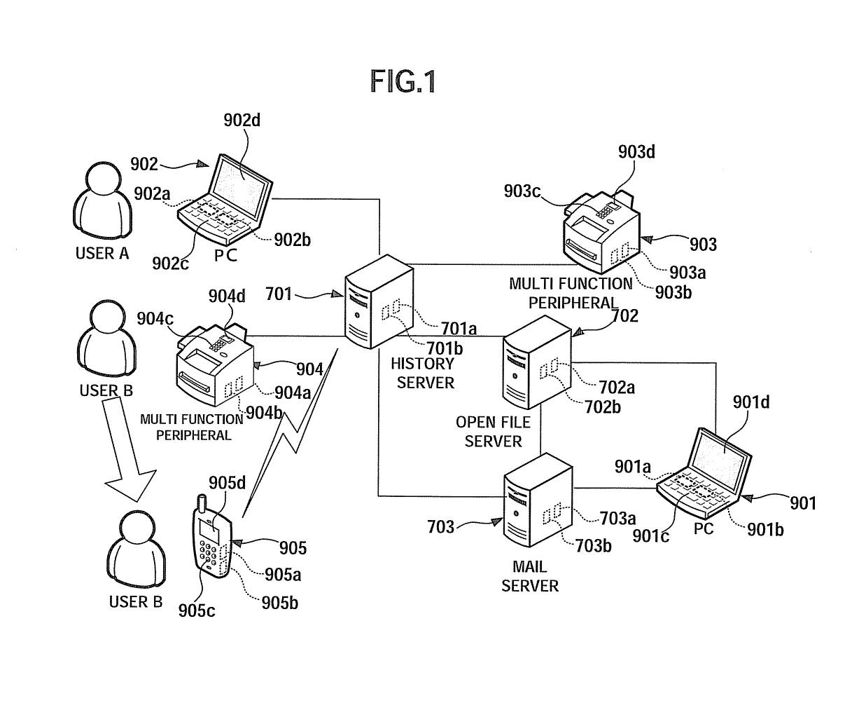

FIG. 1 is a system configuration diagram explaining the schematic configuration of a document management system according to an embodiment of the present invention.

As shown in FIG. 1, the document management system according to the present embodiment includes a Personal Computer (PC) 901, a PC 902, a Multi Function Peripheral (MFP) 903, an MFP 904, a portable terminal 905, a history server 701, an open file server 702, and a mail server 703.

The devices configuring the document management system according to the present embodiment are connected to each other via electrical communication lines such as WWW, LAN or WAN so as to communicate with each other. The electrical communication lines for enabling the devices to communicate with each other are not limited to wired communication lines and communication lines such as wireless LAN or the like may be employed.

The history server 701 accumulates information about document data transmitted from each terminal and document data received by each terminal (including information about an ID of a user who handles the document or the like), or the like in the document management system shown in FIG. 1. The history server 701 extracts or generates document images (page images or the like) of a document to be processed by printing, scanning, copying, browsing, mail transmission, uploading or the like by the PC 901, the PC 902, the MFP 903, the MFP 904 and the portable terminal 905, and records all the images together with metadata as logs of documents which were handled in the past.

Information accumulated in the history server 701 includes data transmitted from the open file server 702, the mail server 703, the PC 901, the PC 902, the MFP 903, the MFP 904 and the portable terminal 905 capable of communicating with the history server 701 to the history server 701 as well as data, a command or the like passing through the history server 701.

The open file server 702 is, for example, a WEB server, a FTP server or the like, and uploads a file to a predetermined storage region of the open file server 702 such that data uploaded can be browsed or downloaded by a plurality of unspecific third persons. The open file server 702 transmits a file stored in the storage region or a referred file to the history server 701 in correspondence with metadata.

The mail server 703 transmits an E-mail from each terminal in the document management system shown in FIG. 1, receives an E-mail to each terminal, and transmits mail data (a mail text, header information, an attached file or the like) transmitted or received through the mail server 703 to the history server 701 as logdata. Information capable of being associated with the mail data or information capable of being extracted from the transmitted or received mail data may be transmitted to the history server 701 as the metadata.

The PC (Personal Computer) 901 may, for example, upload data to the storage region of the open file server 702 or download or browse data uploaded to the storage region of the open file server 702. In addition, the PC 901 transmits or receives an E-mail through the mail server 703.

The PC 902 may, for example, utilize the process such as printing, copying, scanning or the like of the MFP 903 and the MFP 904 through the history server 701. The processed contents or the processed results executed by the MFP 903 and the MFP 904 are accumulated in the history server 701 as logs by a command from the PC 902. The PC 901 may also utilize the process such as printing, copying, scanning or the like of the MFP 903 and the MFP 904 through the history server 701.

The MFP 903 and the MFP 904 can execute a process such as printing, copying, scanning, a FAX transmission or the like, based on the reception of commands from the PC 901, the PC 902 and the portable terminal 905 through a network or a direct operation of the MFP itself. The MFP 903 and the MFP 904 can extract information (user ID or the like) for identifying a user, who transmits the command, from the contents of the command transmitted from the terminal for giving a process execution command. If any one of the above-described processes is executed by the MFP 903 and the MFP 904, metadata such as the user ID or the like is transmitted to and stored in the history server 701 together with an image history of the document to be processed by the MFP.

The portable terminal 905 is, for example, a portable communication terminal such as a mobile phone, a notebook type PC, a personal digital assistant (PDA) or the like, and allows information or a file stored in the history server 701, the open file server 702 or the like to be browsed.

In addition, in the document management system according to the present embodiment, reporting due to transmission of a mail from the history server 701, the open file server 702, the mail server 703 and the like to the PC 901, the PC 902, the portable terminal 905 and the like can be executed.

In addition, the PC 901, the PC 902, the portable terminal 905, the MFP 903, the MFP 904, the history server 701, the open file server 702 and the mail server 703 have a CPU 901a, a CPU 902a, a CPU 905a, a CPU 903a, a CPU 904a, a CPU 701a, a CPU 702a, and a CPU 703a, respectively (see FIG. 1). In addition, the PC 901 to the mail server 703 have a memory 901b, a memory 902b, a memory 905b, a memory 903b, a memory 904b, a memory 701b, a memory 702b and a memory 703b, respectively (see FIG. 1).

The PC 901 to the portable terminal 905 have an operation input unit 901c, an operation input unit 902c, an operation input unit 903c, an operation input unit 904c and an operation input unit 905c, respectively (see FIG. 1). In addition, the PC 901 to the portable terminal 905 have a display unit 901d, a display unit 902d, a display unit 903d, a display unit 904d and a display unit 905d, respectively (see FIG. 1).

In detail, the CPU 901a to the CPU 703a perform various processes of the document management system and realize various functions by executing programs stored in the memory 901b to the memory 703b. The memory 901b to the memory 703b may be, for example, composed of a Random Access Memory (RAM), a Read Only Memory (ROM), a Dynamic Random Access Memory (DRAM), a Static Random Access Memory (SRAM), a Video RAM (VRAM) or the like, and store a variety of information or programs used in the document management system.

The operation input unit 901c to the operation input unit 905c may be, for example, composed of a keyboard, a mouse, a touch panel, a touchpad, a graphics tablet or the like.

The display unit 901d to the display unit 905d may be, for example, composed of a Liquid Crystal Display (LCD), an Electronic Luminescence (EL), a Plasma Display Panel (PDP), a Cathode Ray Tube (CRT) or the like.

In addition, the functions of the operation input units and the display units can be realized by a so-called touch panel display.

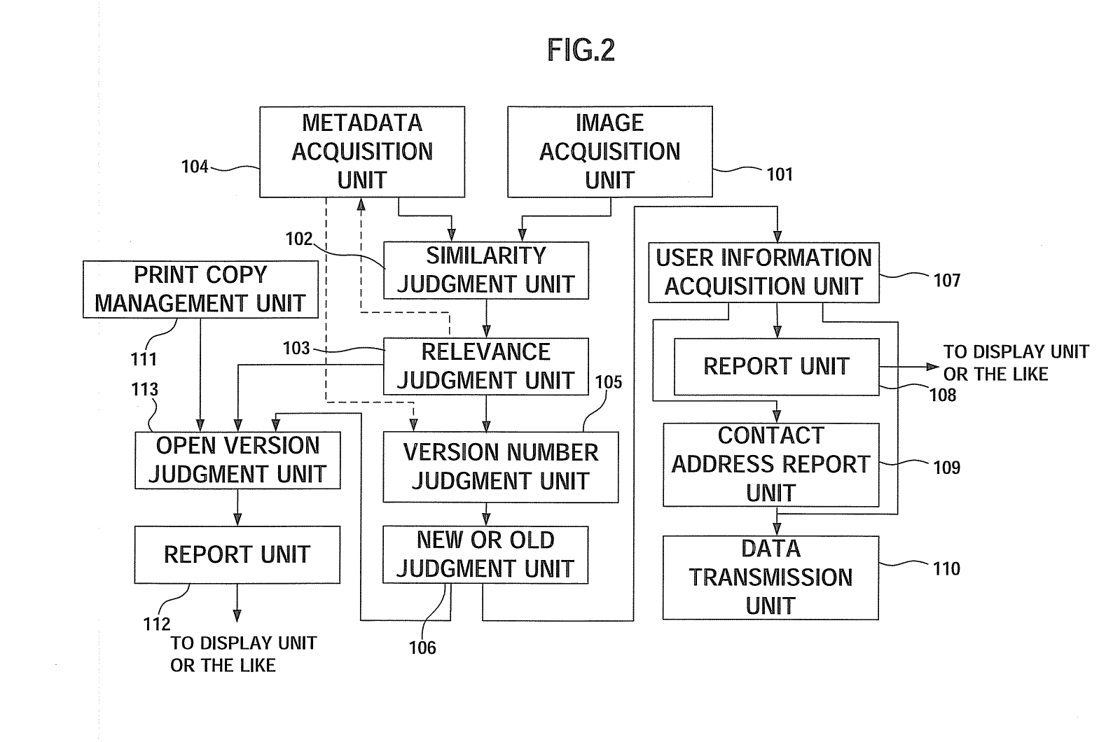

FIG. 2 is a functional block diagram explaining the document management system according to the embodiment of the present invention.

The document management system according to the embodiment of the present invention includes an image acquisition unit 101, a similarity judgment unit 102, a relevance judgment unit 103, a metadata acquisition unit 104, a version number judgment unit 105, a new or old judgment unit 106, a user information acquisition unit 107, a report unit 108, a contact address report unit 109, a data transmission unit 110, a print copy number management unit 111, a report unit 112, and an open version judgment unit 113.

The image acquisition unit 101 acquires a document image representing the contents of a document as a management object.

The image acquisition unit 101 automatically acquires a document image with respect to a document of which at least one of “printing”, “FAX transmission” and “scanning” is executed by executing the above-described process. In detail, the acquisition of the document image by the image acquisition unit 101 may be realized by generating the image based on a document file which is an acquisition object or extracting the image from a document file which is an acquisition object.

The image acquisition unit 101 may generate the document image even with respect to a document which is output as data, for example, as generation of a PDF file from document data, in the document management system.

The similarity judgment unit 102 judges similarity between the contents of a “first document image” acquired by the image acquisition unit 101 and a “second document image” (different from the first document image) acquired by the image acquisition unit 101.

When the document is input to or output from the terminals configuring the document management system, data about the document to be input or output is automatically transmitted to the history server 701 and the similarity with the document image of the logs stored in the history server 701 is automatically judged such that the user knows the existence of the document similar to the document handled by the user without special awareness.

In detail, the similarity judgment unit 102 judges the similarity based on at least one of the “layout of a object to be displayed”, the “shape of the object to be displayed”, the “color of the object to be displayed” and the “number of objects to be displayed” on the document image. In addition, with respect to the judgment of the similarity based on the “layout of the object to be displayed” or the “shape of the object to be displayed” on the document image, for example, a state of applying scaling such as “2 in 1” or the like may be considered.

In addition, the similarity judgment unit 102 may extract text data from the document image by an OCR process or the like, calculate a matching rate of a string based on the contents of the extracted text data, and judge the similarity. In the judgment of the similarity based on the string, not only the contents of the string, but also decoration (for example, bold, italic, underline or the like) applied to a character or the font of a character or the like may be employed as a judgment criterion of the matching rate.

In addition, in the judgment of the similarity by the similarity judgment unit 102, the matching rate of a figure or table capable of being extracted from the document image is judged after being converted into a vector image such that improvement of judgment accuracy can be expected. In addition, a string, a figure, a photo image and the like included in the document image are divided into individual block regions, and the similarity of each of the block regions is judged such that similarity can be judged with high accuracy.

In addition, the similarity of the text data extracted from the document image by the OCR process is judged by utilizing, for example, a diff tool or the like of UNIX (registered trademark) such that the similarity judgment including fine items such as additional writing, deletion, revision and the like can be performed.

In addition, with respect to the similarity judgment process of the text data extracted from the document image by the OCR process, if necessary, the similarity of the text data after translation may be judged. Since translation contents with a certain degree of accuracy or more may not be obtained by a simple machine translation, the similarity judgment of a document of which translation is reliable, such as a patent document, seems to be particularly valid.

In addition, with respect to the similarity judgment of the text data extracted from the document image by the OCR process, the similarity may be judged in consideration of paraphrase of a word, such as thesaurus (synonym).

The relevance judgment unit 103 judges that a “document corresponding to the first document image” and a “document corresponding to the second document image” represent the same object item, if the similarity between the “first document image” and the “second document image” judged by the similarity judgment unit 102 exceeds a predetermined threshold value.

The “representation of the same object item” indicates a state in which both the descriptions are strictly identical or the same theme is described although both the descriptions are not strictly identical, for example, when a plurality of documents are compared.

For example, a document file of a “patent proposal material of an in-company reference number 1234” stored on March 3 and a document file of a “patent proposal material of an in-company reference number 1234” stored on March 5 after revision of the file are not strictly identical although they are similar to each other in the layout such as arrangement of the text or the figure thereof or the like, because revision is performed. However, since they have the same theme (same object item) in view of the patent proposal material attached with the in-company reference number 1234, they have at least a certain degree of similarity.

The metadata acquisition unit 104 acquires information indicating at least one of a “final storage timing”, a “final update timing” and a “final access timing” of each of a plurality of documents judged to represent the same object item by the relevance judgment unit 103 as metadata. In addition, as denoted by a solid arrow of FIG. 2, the data may be acquired by the metadata acquisition unit 104 concurrently with the acquisition of the document image by the image acquisition unit 101.

The version number judgment unit 105 judges whether or not the version number of each document is equal to or different from (different from or not (equal to or not)) those of other documents, in the plurality of documents judged to represent the same object item by the relevance judgment unit 103, based on the judged result of the similarity judgment unit 102.

The old or new judgment unit 106 judges that the version number of a document of which a timing (for example, final update date and time or the like) represented by metadata corresponding thereto is late is new, based on the information acquired by the metadata acquisition unit 104.

The user information acquisition unit 107 acquires information about the users corresponding to the plurality of documents judged to represent the same object item by the relevance judgment unit 103. In detail, the user information acquisition unit 107 acquires a user ID or a terminal ID (a MAC address, an IP address or the like) as information for identifying the users corresponding to the document images managed by the history server 701. In addition, the history server 701 acquires information about a contact address (an E-mail address, a FAX number, a phone number, an IP address, a URL or the like) of the user corresponding to the identification information based on the information for identifying the users, and manages the information about the contact address corresponding to the information for identifying the user.

The report unit 108 reports a “first user” corresponding to a document judged as a version number older than a version number judged as a newest version by the new or old judgment unit 106 to a “second user” corresponding to a document judged as the newest version by the new or old judgment unit 106, with respect to a plurality of documents judged to represent the same object item by the relevance judgment unit 103, based on the information acquired by the user information acquisition unit 107.

The contact address report unit 109 reports the contact address of the second user to the first user. In detail, the contact address report unit 109 acquires the contact address of the second user from the history server 701 based on the information acquired by the user information acquisition unit 107. By reporting the contact address of the user who holds the document of the newest version to the user who holds the document of the old version number, the user who holds the document of the old version number can request the provision of the document of the newest version and generation of re-processing of the operation can be avoided.

In addition, the data transmission unit 110 transmits the document judged as the newest version to the first user.

The print copy number management unit 111 manages the history of the print copy number of the document which is the management object in the document management system. In addition, the history of the print copy number managed by the print copy number management unit 111 can be, for example, managed by the history server 701.

In addition, the report unit 112 reports that the document judged as the version number older than the version number judged as the newest version by the new or old judgment unit 106 is printed and output by a predetermined print copy number or more to the second user corresponding to the document judged as the newest version, based on the print copy number managed by the print copy number management unit 111.

The open version judgment unit 113 judges a document of which a total print copy number managed by the print copy number management unit 111 is the predetermined print copy number or more as a “document of an open version.”

The open version judgment unit 113 judges that a possibility that the document of which the total print copy number managed by the print copy number management unit 111 is large is the document of the “open version” is high.

In addition, the open version judgment unit 113 judges at least one of a document attached to a mail transmitted from the mail server 703 to a predetermined number or more of destinations and a document uploaded to a predetermined storage region (for example, a region capable of being browsed by a plurality of unspecific users, such as a bulletin board) of the open file server 702 as the open version.

Subsequently, the process of the document management system according to the present embodiment will be described.

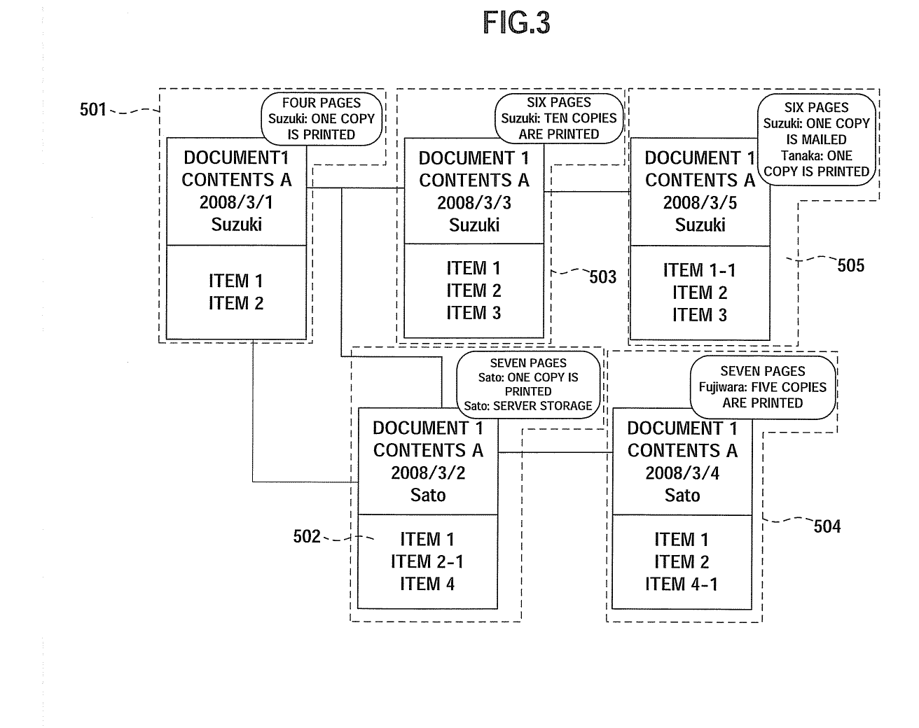

FIG. 3 is a view showing an example of information such as a document accumulated in the history server 701, metadata about the document and the like. In FIG. 3, for convenience of description, a document group configured by a document 501 to a document 505 having a certain relevance is shown.

As shown in FIG. 3, a document file itself of five documents and information associated with the document file are stored in the history server 701 (see regions 501 to 505 denoted by dotted lines).

The information associated with the five documents stored in the history server 701 includes the following (1) to (5).

(1) a document created by Suzuki on March 1 (see a region 501 denoted by a dotted line)

The number of pages is four, one copy is printed by Suzuki, and the document is stored in the history server 701.

(2) a document updated by Sato on March 2 based on Suzuki's document (see a region 502 denoted by a dotted line)

The number of pages is seven, one copy is printed by Sato, and the document is stored in the history server 701.

(3) a document updated by Suzuki on March 3 based on the document stored by Suzuki himself on March 1 (see a region 503 denoted by a dotted line)

The number of pages is six, ten copies are printed by Suzuki, and the document is stored in the history server 701. Since the print copy number is as many as 10, there is a possibility that the document is actually used (opened) in a conference or the like.

(4) a document updated by Sato on March 4 based on the document stored by Sato himself on March 2 (see a region 504 denoted by a dotted line)

The number of pages is seven, five copies are printed by Fujiwara, and the document is stored in the history server 701.

(5) a document updated by Suzuki on March 5 based on the document stored by Suzuki himself on March 3 (see a region 505 denoted by a dotted line)

The number of pages is six, one copy is printed by Suzuki, and one copy is printed by Tanaka. In addition, the document is stored in the history server 701.

The metadata capable of being managed by the history server 701 in association with the document file is, for example, as follows. The history server 701 extracts the following (a) to (i) from the file transmitted through the history server 701 or receives the following (a) to (i) from the PC 901, the PC 902, the portable terminal 905, the MFP 903, the MFP 904, the history server 701, the open file server 702 and the mail server 703.

(a) document name

(b) document page number

(c) operation date and time

(d) holder

(e) operator

(f) operated material

(g) operated contents (copy, FAX, print, mail browse, mail transmission, PDF file generation, server storage, bulletin board browse or the like)

(h) copy number (copy number in the case of print or copy and the number of destinations in the case of a FAX or a mail)

open range in the case of a bulletin board or an open server (browse authority number, which is multiplied by a coefficient if necessary)

(i) open flag

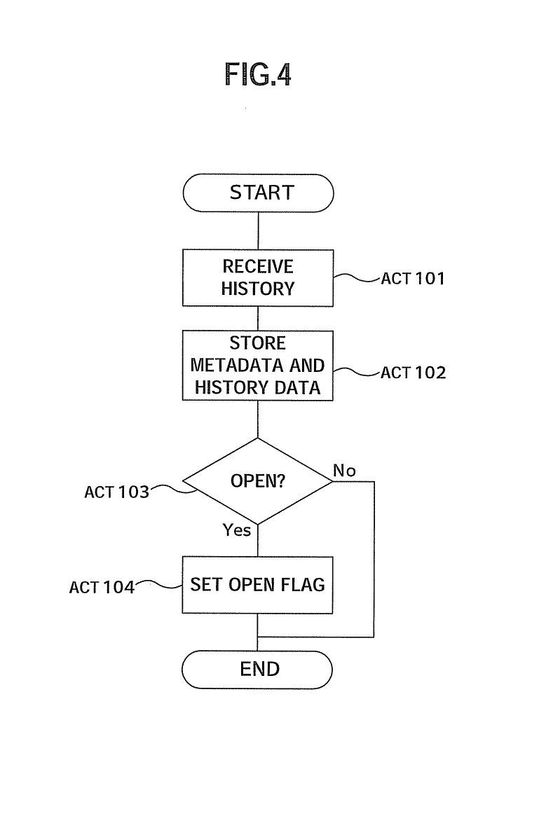

FIG. 4 is a flowchart explaining a process of the document management system according to the present embodiment.

For example, if the MFP 903 or the MFP 904 executes copying by an instruction of the PC 901, the PC 902 or the like, the image acquisition unit 101 transmits a document image (copy image) scanned and printed by the copying to the history server 701 as the history of a document which is an object of the copying (ACT101).

The storage of data about the document based on the copying or the like of the MFP does not need to be necessarily performed with respect to the history server 701, and, for example, may be performed with respect to the open file server 702, the mail server 703, a document management server (not shown), the PC 901 or the PC 902.

The history server 701 stores the document image transmitted as described above and metadata associated with the document image (ACT102).

Subsequently, the open version judgment unit 113 judges whether a document judged as an open version is present in a document of which a document image is stored in the history server 701 and a document which is input to or output from the history server 701 (ACT103).

If the open version judgment unit 113 judges that the document judged as the open version is present (ACT103, Yes), an “open flag” is set as metadata corresponding to the document, and the document image of the document and the open flag are stored in the history server 701 (ACT104).

In addition, a criterion for judging “open” by the open version judgment unit 113 includes, for example, as follows:

(1) a case where a predetermined number or more of copies is printed or copied

(2) a case where a mail is transmitted to a predetermined number or more of destinations

(3) a case where the document is stored in a place capable of being accessed by a plurality of users, such as a bulletin board, an open file server or the like.

Subsequently, in the present embodiment, the configuration for issuing a warning that a document of a version number newer than that of the old document and having the same theme is present on a user if the document of the old version number is copied by the MFP 903 or the MFP 904 will be described.

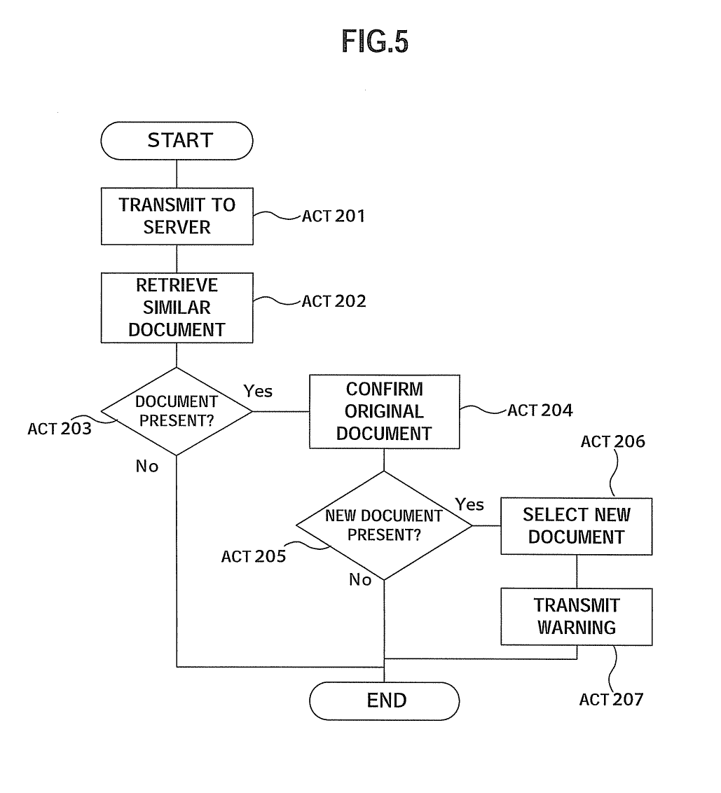

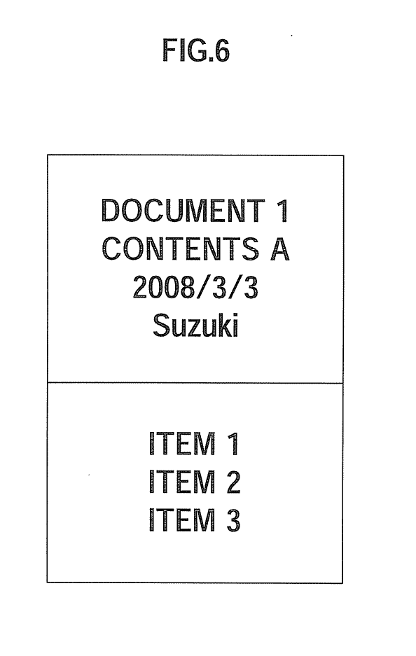

FIG. 5 is a flowchart showing a process when the document 503 (see FIG. 6) of the five documents shown in FIG. 3 is copied by the MFP 903 or the MFP 904.

First, if the copy of the document 503 is directly instructed to the MFP by the operation input of the user, copying using the MFP is started and the document image of the document 503 is transmitted to the history server 701 (ACT201).

The history server 701 retrieves a document having image contents similar to that of the document image (judged by the similarity judgment unit 102) transmitted by copying of the document 503 from a plurality of document image groups stored in the history server 701 (ACT202). In the retrieval of the similar image, a known similar image retrieval technology may be employed. For example, the five documents 501 to 505 shown in FIG. 3 are selected.

If the document similar to the document which is the object of copying is not retrieved (ACT203, No), the process is finished.

In contrast, if the document similar to the document which is the object of copying is retrieved (ACT 203, Yes), the most similar document is decided among the similar documents (ACT204). Here, it is assumed that the document 503 shown in FIG. 3 is selected as the most similar document.

Subsequently, it is judged whether a document having a date newer than the document which is the object of copying is present in the document group judged to represent the same object item as the document 503 by the relevance judgment unit 103, by the version number judgment unit 105 and the new or old judgment unit 106 (ACT205).

Here, the document 504 and the document 505 are selected as the document having the new date (ACT206).

The report unit 108 displays a warning message that a document of a version number newer than that of the document which is the object of copying is present on the screen of at least one of the display unit 901d, the display unit 902d, the display unit 903d, the display unit 904d and the display unit 905d.

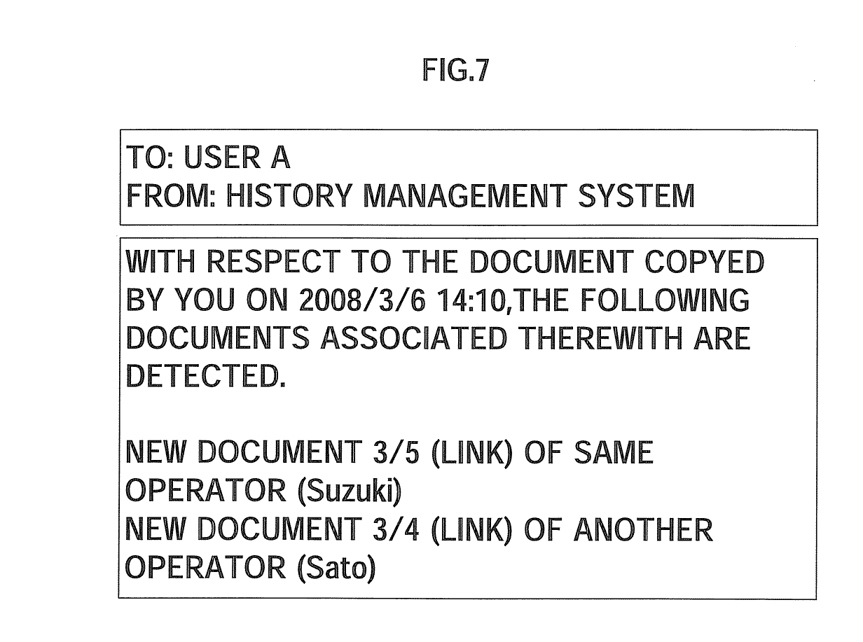

FIG. 7 is a view showing an example of a warning message which is displayed on the screen of a display unit 804 by the report unit 108. On the warning screen of FIG. 7, it is reported that the new document of March 5 by the same operator as the operator (Suzuki) of the document of March 3 and the new document of March 4 by another operator (Sato) are present as the document associated with the document of March 3. In addition, the link to the document data is set in the documents listed up as the associated documents. The user may click the link to access document image data stored in the history server 701.

By employing such a configuration, generation of re-processing of the operation can be avoided and operation efficiency can be improved even in an environment in which a plurality of documents of different version numbers are mixed as the document for representing the same object item.

In addition, although, in the flowchart shown in FIG. 5, the case where a warning that the document of the version number newer than that of the original document which is the object of copying is present is issued by the direct operation of the MFP by the user is shown, the present invention is not limited thereto. For example, it goes without saying that any document image may be transmitted from the PC 902 or the like to the history server 701 and the document which seems to represent the same object item as the document image may be retrieved.

In addition, in ACT202 of the flowchart shown in FIG. 5, for example, only the document 503 of which the date is March 3 and the document 504 of which the date is March 4 are retrieved according to a threshold value used for the judgment of the similar image.

In this case, in ACT204, only the document 505 of which the date is March 5 is retrieved, and, in ACT205, only the document of which the date is March 5 is reported as a new document.

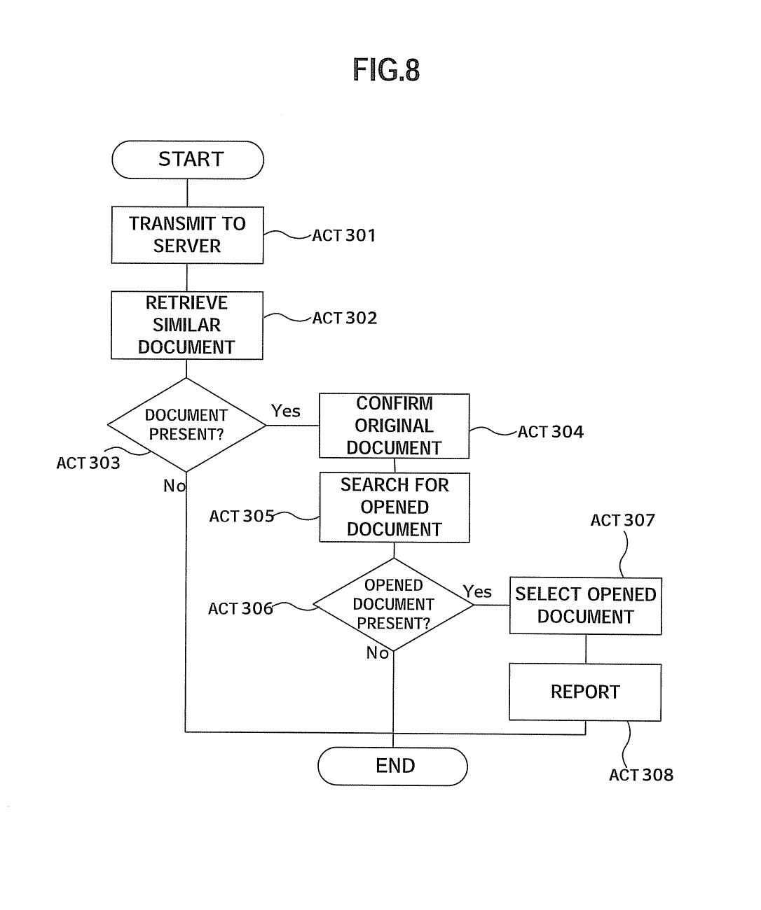

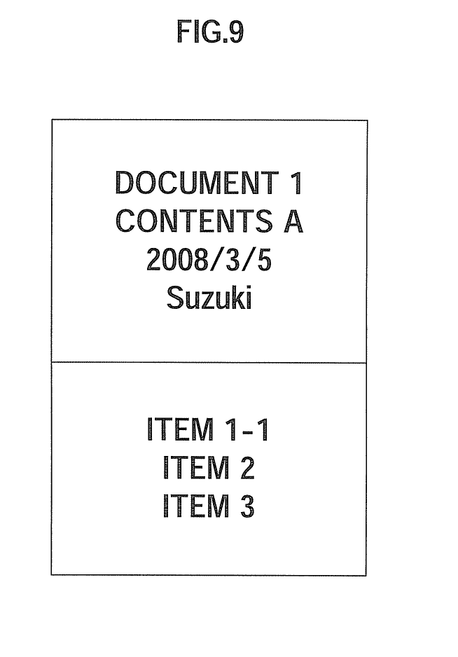

Next, a configuration for selecting an open version from the plurality of document images if a plurality of document images are stored in the history server 701 will be described. FIG. 8 is a flowchart showing a process of selecting an open version. FIG. 9 is a view showing the outline of a document which will be copied by a user. Here, for example, the document 505 of March 5 shown in FIG. 3 will be described.

If the user instructs copying by the MFP 903 or the MFP 904, the MFP which receives the instruction executes copying and the document image of the document which is the object of copying is transmitted to the history server 701 (ACT301).

The history server 701 retrieves a document image having the contents similar to that of the image from the document image group stored in advance, based on the document image transmitted from the MFP (ACT302).

If it is judged that the document image similar to the input document image is not present in the history server (ACT303, No), the process is finished.

In contrast, if the document image similar to the input document image is present in the history server (ACT303, Yes), the version number judgment unit 105 selects a document image having highest similarity rate (ACT304). Here, it is assumed that the document 505 of March 5 is selected.

The open version judgment unit 113 judges whether the document image in which the open flag is set is present in the document image group which is judged to be similar in ACT303 (ACT305).

If the document image in which the open flag is set is not present (ACT306, No), the process is finished.

In contrast, if the document image in which the open flag is set is present (ACT306, Yes), the document is selected (ACT307). Here, the document 503 of March 3 and the document 502 of March 2 are selected.

The report unit 108 reports the document selected by the above-described operation to the user by displaying the selected document on the screen of at least one of the display unit 901d, the display unit 902d, the display unit 903d, the display unit 904d and the display unit 905d (ACT308).

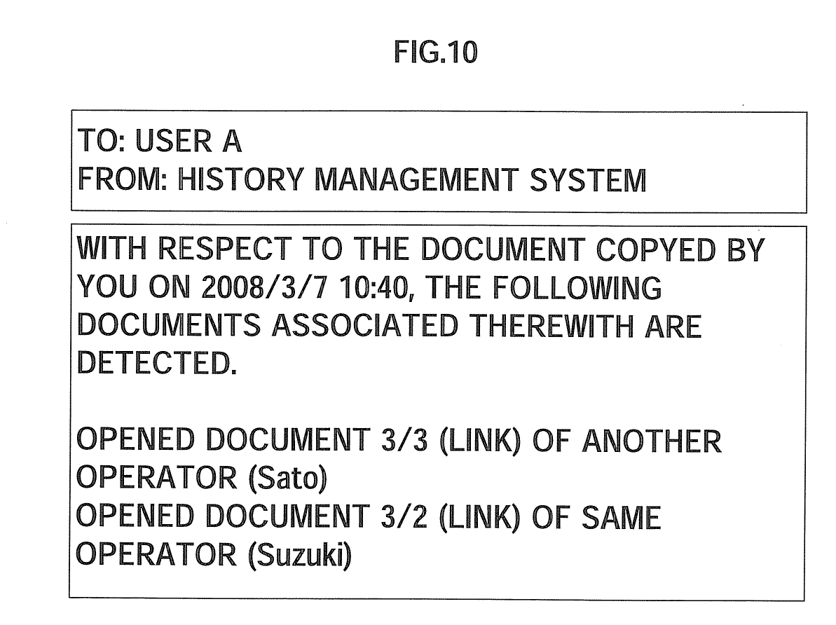

On the warning screen of FIG. 10, it is reported that the document of the open version of March 2 by the same operator as the operator (Sato) of the document of March 5 and the document of the open version of March 3 by another operator are present as the document associated with the document of March 5.

In addition, although, in the flowchart shown in FIG. 8, the case where a warning that the document having the version number newer than that of the original document which is the object of copying is present is issued by the direct operation of the MFP by the user is shown, the present invention is not limited thereto. For example, it goes without saying that any document image may be transmitted from the PC 902 or the like to the history server 701, and the document of the open version may be retrieved among the documents which seem to represent the same object item as the document image.

In addition, the report unit 108 does not need to separately report whether or not a document having the version number newer than that of the document having a certain document image is present and whether or not a document handled as the open version is present in the document group for representing the same object item as the document having a certain document image. That is, it goes without saying that the two reported contents may be simultaneously displayed on the screen of the display unit 804.

In addition, although, in the above-described embodiment, the case where the MFP mainly copies the document is described, the retrieval of the document image group stored in the history server 701 is not limited thereto. For example, if the user operates the PC 902 to open a specific document (a document received using a mail, a document uploaded to the open file server or the like), it may be possible to inquire the history server 701 about whether or not a document having contents similar to that of the document image of the document is present.

Similarly, if the MFP 903 or the MFP 904 is directly operated to perform printing, scanning, FAX processing or the like, it maybe possible to inquire the history server 701 about whether or not a document image having contents similar to that of the document image which is the object of the process is present.

The operations of the process of the above-described document management system are realized by executing the document management programs stored in the memory 901b to the memory 703b on the CPU 901a to the CPU 703a.

In addition, the functions of the image acquisition unit 101, the similarity judgment unit 102, the relevance judgment unit 103, the metadata acquisition unit 104, the version number judgment unit 105, the new or old judgment unit 106, the user information acquisition unit 107, the report unit 108, the contact address report unit 109, the data transmission unit 110, the print copy number management unit 111, the report unit 112 and the open version judgment unit 113 included in the document management system according to the present embodiment may be realized as the whole system, and the function portions may belong to anyone of the PC, the MFP, the server, the portable terminal or the like configuring the document management system.

The computer configuring the document management system can be provided with the programs for executing the above-described ACTs as the document management programs. Although, in the present embodiment, the programs for realizing the functions for embodying the invention are recorded in a storage region included in the device in advance, the present invention is not limited thereto. The same programs may be downloaded from a network to the device, or the same programs stored in a computer-readable recording medium may be installed in the device. The recording medium may have any form if the recording medium can store programs and can be read by a computer. In detail, examples of the recording medium include, for example, an internal storage device mounted in a computer, such as a ROM or a RAM, a transportable storage medium such as a CD-ROM, a flexible disk, a DVD disk, a magnetooptical disk, an IC card, a database for holding a computer program, another computer and a database thereof, a transfer medium on a line, and the like. The function obtained by installation or download in advance can be realized in cooperation with an Operating System (OS) included in the device.

In addition, a program for dynamically generating an execution module is included in the programs according to the present embodiment.

The present invention may be modified without departing from the spirit or the main features of the present invention. Accordingly, the above-described embodiment is only exemplary and the present invention is not limited to the above-described embodiment. The scope of the present invention is described in claims and is not restricted by the specification. In addition, all change, various improvements, replacement, and modification belonging to the range of claims are included in the range of the present invention.

As described above in detail, according to the present invention, it is possible to provide a technology of realizing adequate management of a version number suitable for the actual contents of each of the documents without imparting respective IDs to a plurality of documents which are management objects.

What is claimed is:

1. A document management system comprising:
an image acquisition unit acquiring a document image representing contents of a document as a management object;
a similarity judgment unit judging similarity between contents of a first document image acquired by the image acquisition unit and contents of a second document image acquired by the image acquisition unit;
a relevance judgment unit judging that a document corresponding to the first document image and a document corresponding to the second document image represent the same object item if the similarity between the first document image and the second document image judged by the similarity judgment unit exceeds a predetermined threshold value; and
a version number judgment unit judging whether the version number of each document is equal to or different from those of other documents in a plurality of documents judged to represent the same object item by the relevance judgment unit, based on the judged result of the similarity judgment unit.

2. The system according to claim 1, wherein the similarity judgment unit judges the similarity based on at least one of the layout of an object to be displayed, the shape of the object to be displayed, the color of the object to be displayed and the number of objects to be displayed, on the document image.

3. The system according to claim 1, wherein the similarity judgment unit extracts text data from the document image and judges the similarity based on the contents of the extracted text data.

4. The system according to claim 1, further comprising:
a metadata acquisition unit acquiring information indicating at least one of a final storage timing, a final update timing and a final access timing of each of the plurality of documents judged to represent the same object item by the relevance judgment unit as metadata;
a new or old judgment unit judging that the version number of a document of which a timing indicated by the metadata corresponding thereto is late is new, based on the information acquired by the metadata acquisition unit;
a user information acquisition unit acquiring information about users corresponding to the plurality of documents judged to represent the same object item by the relevance judgment unit; and
a report unit reporting a first user corresponding to a document judged as a version number older than a version number judged as a newest version by the new or old judgment unit to a second user corresponding to a document judged as the newest version by the new or old judgment unit, with respect to the plurality of documents judged to represent the same object item by the relevance judgment unit, based on the information acquired by the user information acquisition unit.

5. The system according to claim 4, further comprising a contact address report unit reporting a contact address of the second user to the first user.

6. The system according to claim 4, further comprising a data transmission unit transmitting the document judged as the newest version to the first user.

7. The system according to claim 1, further comprising:
a metadata acquisition unit acquiring information indicating at least one of a final storage timing, a final update timing and a final access timing of each of the plurality of documents judged to represent the same object item by the relevance judgment unit as metadata;
a new or old judgment unit judging that the version number of a document of which a timing indicated by the metadata corresponding thereto is late is new, based on the information acquired by the metadata acquisition unit;
a print copy number management unit managing the history of a print copy number of the document which is the management object in the document management system; and
a report unit reporting that the document judged as a version number older than a version number judged as a newest version by the new or old judgment unit is printed and output by a predetermined copy number or more to a second user corresponding to a document judged as the newest version by the new or old judgment unit, based on the print copy number managed by the print copy number management unit.

8. The system according to claim 1, further comprising:
a print copy number management unit managing the history of a print copy number of the document which is the management object in the document management system; and
an open version judgment unit judging a document, of which a total print copy number managed by the print copy number management unit is a predetermined print copy number or more, as a document of an open version.

9. The system according to claim 8, wherein the open version judgment unit judges that a possibility that the document of which the total print copy number managed by the print copy number management unit is large is the document of the open version is high.

10. The system according to claim 8, wherein the image acquisition unit acquires the document image with respect to a document of which at least one of printing, FAX transmission and scanning is executed.

11. The system according to claim 8, wherein the open version judgment unit judges at least one of a document attached to a mail transmitted to a predetermined number or more of destinations and a document uploaded to a predetermined storage region for open as the open version.

12. A document management method comprising:
acquiring a document image representing contents of a document as a management object;
judging similarity between contents of an acquired first document image and contents of an acquired second document image;
judging that a document corresponding to the first document image and a document corresponding to the second document image represent the same object item if the judged similarity between the first document image and the second document image exceeds a predetermined threshold value; and
judging whether the version number of each document is equal to or different from those of other documents in a plurality of documents judged to represent the same object item, based on the judged result.

13. The method according to claim 12, wherein the similarity is judged based on at least one of the layout of an object to be displayed, the shape of the object to be displayed, the color of the object to be displayed and the number of objects to be displayed, on the document image.

14. The method according to claim 12, wherein text data is extracted from the document image and the similarity is judged based on the contents of the extracted text data.

15. The method according to claim 12, further comprising:
acquiring information indicating at least one of a final storage timing, a final update timing and a final access timing of each of the plurality of documents judged to represent the same object item as metadata;
judging that the version number of a document of which a timing indicated by the metadata corresponding thereto is late is new, based on the acquired information;
acquiring information about users corresponding to the plurality of documents judged to represent the same object item; and
reporting a first user corresponding to a document judged as a version number older than a version number judged as a newest version to a second user corresponding to a document judged as the newest version, with respect to the plurality of documents judged to represent the same object item, based on the acquired information.

16. The method according to claim 15, further comprising reporting a contact address of the second user to the first user.

17. The method according to claim 12, further comprising:
acquiring information indicating at least one of a final storage timing, a final update timing and a final access timing of each of the plurality of documents judged to represent the same object item as metadata;
judging that the version number of a document of which a timing indicated by the metadata corresponding thereto is late is new, based on the acquired information;
managing the history of a print copy number of the document which is the management object; and
reporting that the document judged as a version number older than a version number judged as a newest version is printed and output by a predetermined copy number or more to a second user corresponding to a document judged as the newest version, based on the managed print copy number.

18. The method according to claim 12, further comprising:
managing the history of a print copy number of the document which is the management object in the document management method; and
judging a document, of which a managed total print copy number is a predetermined print copy number or more, as a document of an open version.

19. The method according to claim 18, wherein it is judged that a possibility that the document of which the managed total print copy number is large is the document of the open version is high.

20. The method according to claim 18, wherein at least one of a document attached to a mail transmitted to a predetermined number or more of destinations and a document uploaded to a predetermined storage region for open is judged as the open version.
